(19) United States
(12) Patent Application Publication
(10) Pub. No.: US 2018/0155006 A1
(43) Pub. Date: Jun. 7, 2018

(54) AIRCRAFT STABILIZER LEADING EDGE INTEGRATION WITH TORSION BOX AND FUSELAGE

(71) Applicant: AIRBUS OPERATIONS, S.L., Getafe (ES)

(72) Inventors: Alberto ARANA HIDALGO, Getafe (ES); Esteban MARTINO GONZÁLEZ, Getafe (ES); Jesús Javier VÁZQUEZ CASTRO, Getafe (ES); Pablo CEBOLLA GARROFE, Getafe (ES)

(21) Appl. No.: 15/801,669

(22) Filed: Nov. 2, 2017

(30) Foreign Application Priority Data
Dec. 2, 2016 (EP) 16382587.0

(51) Int. Cl. B64C 5/02; B64C 1/26; B64C 3/28

(52) U.S. Cl. CPC B64C 5/02; B64C 1/065; B64C 3/28; B64C 1/26

(57) ABSTRACT

An aircraft stabilizer (15, 17) with an enlarged area of laminar flow. The lateral skins (45a, 45b; 65a, 65b) of its torsion box (43; 63) include joggled areas (53a, 53b; 73a, 73b) as attachment areas of its leading edge (41; 61) which are arranged in a rearward position with respect to the forward most spar of the stabilizer (15, 17).

### RELATED APPLICATION

This application claims priority to European Patent Application 16382587.0, filed Dec. 2, 2016, the entirety of which is incorporated by reference.

### FIELD OF THE INVENTION

The present invention relates to the integration of the leading edge with the torsion box in aircraft stabilizers.

### BACKGROUND

A known aircraft stabilizer (stabilizer or tail plane) is structured by a leading edge, a torsion box, and a trailing edge.

The leading edge should meet all or most of the following requirements:

(A) Maintain aerodynamic shape in the front of the torsion box;

(B) Transfer the aerodynamic forces from the leading edge to the torsion box;

(C) Assist in maintaining the integrity of the torsion box in adverse conditions such as for example in the case of a bird impact;

(D) Resist erosion during cruise flight;

(E) Be removable to allow access to the torsion box; and

(F) Provide space for installation of systems and routings.

The torsion box is a primary structure responsible of supporting all loads on the stabilizer. The torsion box has structural elements including: skins stiffened by stringers, and internal spars and ribs.

FIGS. 1, 2a, 2b, 2c and 2d show a known integration of a leading edge 21 with the torsion box 23 of the stabilizer of an aircraft 11 placed over the rear end of the fuselage 13. The torsion box 23 comprise lateral skins 25a, 25b rigidized by stringers 26, a front spar 27, a rear spar 29 and intermediate spars 31 and the integration is made joining the ends of the leading edge 21 to frontal joggled areas 33a, 33b of the lateral skins 25a, 25b. The stabilizer further comprises a trailing edge 22.

The torsion box 23 is a multi-spar torsion box that can be manufactured by the method disclosed in U.S. Pat. No. 7,806,367 B2.

A drawback of this integration is that the transition, e.g., joint, from the leading edge 21 to the lateral skins 25a, 25b of the torsion box 23 can cause reduce laminar flow over the skin of the aircraft stabilizer due to surface discontinuities, fasteners mount steps or other conditions at the transition. Thus, the laminarity of the flow over the skin of the stabilizer may be reduced as the flow moves past the rear edges of the leading edge 21 and across the transition to the torsion box.

The invention is addressed to the solution of this drawback.

### SUMMARY OF THE INVENTION

The invention refers to aircraft stabilizers and in particular to the integration of the leading edge with the torsion box. The invention provides a stabilizer configuration with the joggled areas of the lateral skins of the torsion box that serve as attachment areas of the leading edge being arranged in a rearward position with respect to the forward most spar of the aircraft stabilizer.

This configuration enlarges the surface area of the leading edge on the stabilizer and thereby promotes laminar flow over the stabilizer.

In an embodiment of the invention, a leading edge comprises a skin, a spar within the skin and joggled areas arranged rearward of the spar.

In another embodiment, a torsion box comprises a rounded front spar, a rear spar and intermediate spars and lateral skins including joggled areas formed by recessed areas extending from at least the first intermediate spar to the rounded front spar to accommodate a skin the leading edge fitting over at least the rounded front spar. The joggled areas of the leading edge seat in the recessed areas of the lateral skins of the torsion box, such that the joggled areas are rearward of the rounded front spar.

Other characteristics and advantages of the present invention will be clear from the following detailed description of embodiments illustrative of its object in relation to the attached drawings.

### BRIEF DESCRIPTION OF THE DRAWINGS

FIG. 1 is a partial schematic perspective view of the upper rear end of an aircraft fuselage illustrating a known joint of the stabilizer to the fuselage and the main components of the stabilizer: the leading edge (in phantom lines) and the torsion box.

FIGS. 2a, 2b and 2c show separate perspective views of the leading edge, the torsion box and the resulting stabilizer in the known configuration.

FIG. 2d is a cross sectional view by a horizontal plane of the stabilizer of FIG. 2a illustrating the integration of the leading edge with the torsion box.

FIGS. 3a and 3b show separate perspective views of the leading edge, the torsion box and the resulting stabilizer illustrating an embodiment of the invention.

FIG. 3c is a cross sectional view by a horizontal plane of the stabilizer of FIG. 3a illustrating the integration of the leading edge with the torsion box.

FIGS. 4a to 4c shows separate perspective views of the leading edge, the torsion box and the resulting stabilizer illustrating another embodiment of the invention.

FIG. 4d is a cross sectional view by a horizontal plane of the stabilizer of FIG. 4a illustrating the integration of the leading edge with the torsion box.

### DETAILED DESCRIPTION OF THE INVENTION

The invention proposes that the integration of the leading edge with the torsion box takes place in a backward position than in known configurations to enlarge the stabilizer area with a laminar flow (the term backward shall be understood in relation to the fly direction of the aircraft).

In the embodiment illustrated in FIGS. 3a, 3b, the stabilizer 15 of aircraft 11 comprises a torsion box 43 and a leading edge 41. The torsion box 43 comprise lateral skins 45a, 45b, rigidized by stringers 46, with frontal joggled areas 53a, 53b, a front spar 47, a rear spar 49 and an intermediate spar 51. The joggled areas may be ribs extending forward of a front spar 47 of the torsion box and extending along a vertical length of the torsion box. The joggled areas may be formed from the lateral skins of the torsion box or by another rigid structure, such as a composite rib, extending forward of the front spar 47.

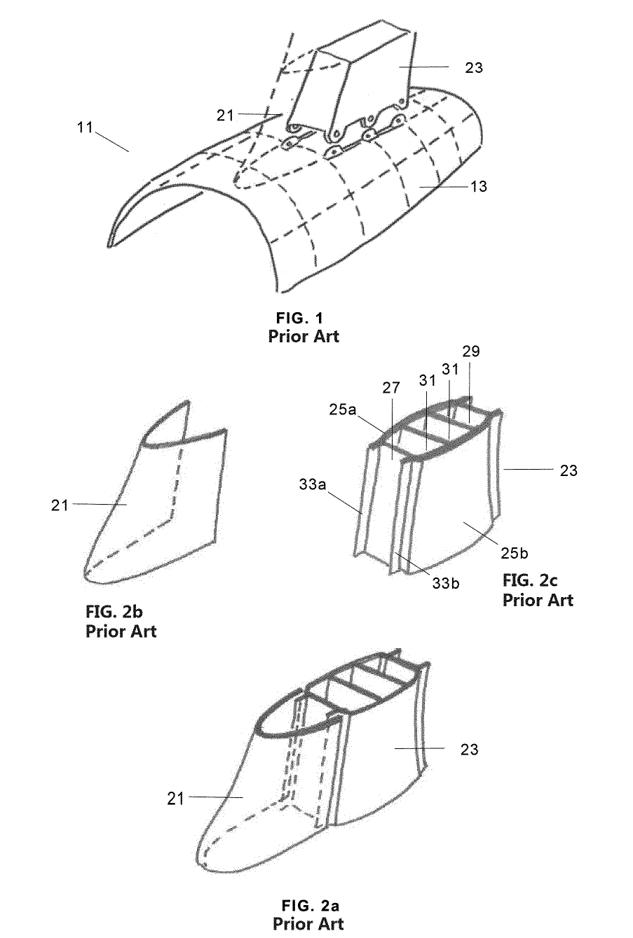

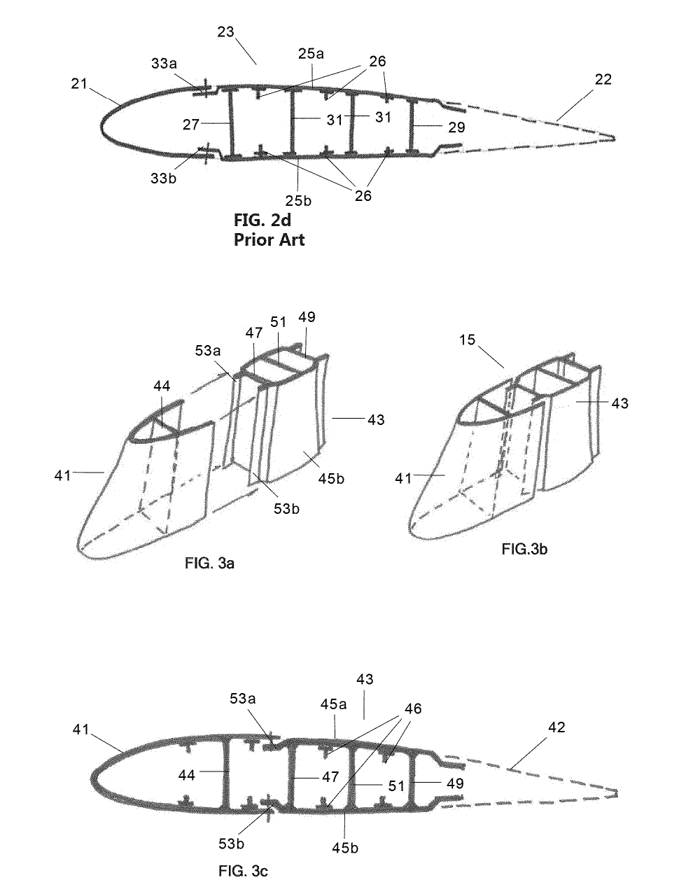

The leading edge 41 is longer in a direction parallel to an axis of the fuselage than the leading edge 21 shown in FIGS. 2a and 2b. The leading edge 41 comprises a skin and a spar 44 within the skin. The skin has an outer surface forming the front outer surface of the stabilizer. The outer skin extends rearward of the spar 44 and is attached to the torsion box 43 at the frontal joggled areas 53a, 53b of the torsion box.

The torsion box 43 may have a shorter length than the torsion box 23 shown in FIG. 2a because the torsion box 43 may have at least one fewer spars than the torsion box 23. The frontal joggled areas 53a, 53b are placed in a rearward position with respect to the frontal joggled areas 33a, 33b of FIGS. 2a and 2c. In particular, the frontal joggled areas 53a, 53b of the torsion box 43 are in rearward of the spar 44 in the leading edge 41.

The skin of the leading edge 41 extends rearward past the front spar 44 and thereby enlarges surface area of the leading edge. The joint between the skin of the leading degree 41 and the joggled areas 53a, 53b of the torsion box 43 is shifted rearward (as compared to the leading edge 21) by including a front spar in the leading edge 41. Shifting the joint rearward, allows the smooth surface of the leading edge to continue further rearward as compared to the leading edge 21. Extending the smooth surface of the leading edge before the joints at the joggle areas 53a, 53b increases the smooth surface area that promotes laminar flow before the surface area reaches the joints.

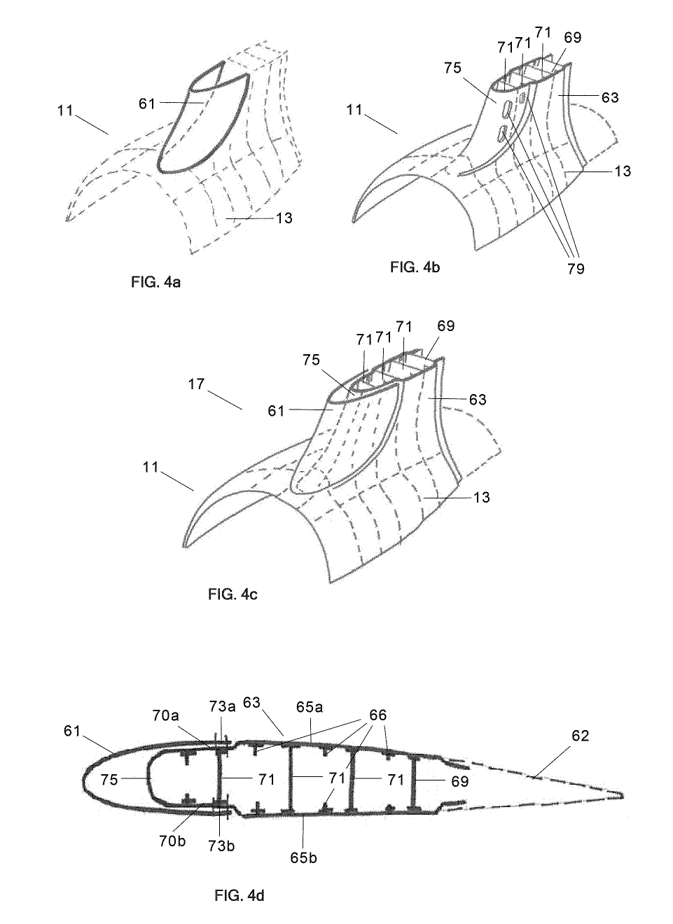

In the embodiment illustrated in FIGS. 4a, 4b, the stabilizer 17 of aircraft 11 comprises a torsion box 63 and a leading edge 61. The torsion box 63 comprises lateral skins 65a, 65b, rigidized by stringers 66, a rounded front spar 75 (acting as a “false” leading edge of the torsion box), a rear spar 69 and intermediate spars 71.

The lateral skins 65a, 65b include recessed areas 70a, 70b in its frontal section to allow the accommodation of the leading edge 61 over them maintaining the aerodynamic continuity in the external surface of the stabilizer 17.

The recessed areas 70a, 70b cover at least the space between the first intermediate spar 71 (the contiguous spar to the rounded front spar 75) and the rounded front spar 75 and include in its rear end joggled areas 73a, 73b for attaching the leading edge 61 to the torsion box 63.

Access holes 79 at certain locations between the rounded front spar 75 and the first intermediate spar 71 receive fasteners or other attachments devices to secure the leading edge to the torsion box.

The joggled areas 73a, 73b are arranged in a rearward position with respect to the rounded front spar 75.

A benefit of closing the front portion of the torsion box 63 with a rounded front spar 75 is that it allows the transition of that “false” leading edge to the surface of the fuselage 13.

Another advantage of the invention is that simplifies the attachment of the leading edge to the torsion box.

Although the present invention has been described in connection with various embodiments, it will be appreciated from the specification that various combinations of elements, variations or improvements therein may be made, and are within the scope of the invention as defined by the appended claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft stabilizer comprising:
a leading edge, a torsion box and a trailing edge;
wherein the leading edge being configured with an aerodynamic shape suitable to promote a laminar flow on an outer surface of the leading edge;
wherein lateral skins of the torsion box include joggled areas as attachment areas for the leading edge; and
wherein the joggled areas extend rearward of a forward most spar in the aircraft stabilizer.

2. The aircraft stabilizer according to claim 1, wherein:
the torsion box comprises a front spar and a rear spar;
the leading edge comprises the forward most spar; and
the joggled areas are rearward of the forward most spar of the leading edge.

3. The aircraft stabilizer according to claim 2, wherein the torsion box further comprises at least one intermediate spar.

4. The aircraft stabilizer according to claim 1, wherein the front spa includes a rounded portion, the torsion box includes intermediate spars, and wherein the lateral skins include recessed areas extending from the at least one intermediate spar to the rounded portion of the front spar; and
the joggled areas are arranged in the recessed areas in a rearward position with respect to the front spar.

5. The aircraft stabilizer according to claim 4, wherein the front spar has a curved shape.

6. An aircraft comprising a stabilizer according to claim 1.

7. A stabilizer for an aircraft comprising:
a torsion box including lateral skins on opposite sides of the torsion box, spars extending between the lateral skins, and joggled elements extending along at least a portion of a length torsion box, wherein the spars include a front spar in the torsion box and the joggled elements extend rearward of a forward most spar in the stabilizer; and
a leading edge including a skin, wherein rear edges of the skin are attached to the joggled elements of the torsion box.

8. The stabilizer of claim 7 wherein the rear edges extend the length of the torsion box and the rear edges of the skin of the leading edge are aligned with the lateral skins of the torsion box.

9. The stabilizer of claim 7 wherein the leading edge includes the forward most spar which spans between opposite sections of the skin.

10. The stabilizer of claim 7 wherein the leading edge includes a stringer on an inside surface of the skin and the stringer is forward of the forward most spar.

11. The stabilizer of claim 7 wherein the torsion box includes a forward portion having a narrower width than a rearward portion of the torsion box, and the forward portion includes the forward most spar.

12. The stabilizer of claim 11 wherein the forward portion of the torsion box is U-shaped in cross section.

13. The stabilizer of claim 11 wherein the forward portion of the torsion box includes portions of the lateral skins that form the joggled elements.

14. The stabilizer of claim 7 wherein the skin of the leading edge has a U-shape in cross section.

15. The stabilizer of claim 7 wherein the joggled elements are ribs projecting forward from a front spar of the torsion box.
